(19) United States
(12) Patent Application Publication
(10) Pub. No.: US 2026/0145707 A1
(43) Pub. Date: May 28, 2026

(54) VEHICLE CONTROL DEVICE AND METHOD

(71) Applicants: Hyundai Motor Company, Seoul (KR); Kia Corporation, Seoul (KR)

(72) Inventors: Sung Hwan YUN, Hwaseong-Si (KR); Min Sung KIM, Hwaseong-Si (KR); Sung Woo JANG, Hwaseong-Si (KR); Dong Gyu KIM, Hwaseong-Si (KR); Ji Hong KIM, Hwaseong-Si (KR)

(21) Appl. No.: 19/227,909

(22) Filed: Jun. 4, 2025

(30) Foreign Application Priority Data
Nov. 27, 2024 (KR) 10-2024-0171923

(51) Int. Cl. B60W 60/00; B60W 30/18; G06V 20/56; G06V 20/58; H04W 4/46

(52) U.S. Cl. CPC B60W 60/0015; B60W 30/18163; G06V 20/58; G06V 20/588; H04W 4/46; B60W 2420/403; B60W 2420/408; B60W 2520/10; B60W 2520/18; B60W 2540/18; B60W 2552/35; B60W 2552/53; B60W 2554/4042; B60W 2554/4044; B60W 2556/65

(57) ABSTRACT

An apparatus of a vehicle includes one or more processors and a memory storing one or more programs that, when executed by the one or more processors communicating with the memory, are configured to cause the apparatus to estimate, based on a driving image of a preceding vehicle captured by a camera of the vehicle, a roll rate of the preceding vehicle, determine a possibility of a pothole avoidance, wherein the possibility is determined based on the roll rate of the preceding vehicle, driving information about the preceding vehicle, and driving information about the vehicle, output a signal indicating the possibility, and control, based on the signal and based on an estimated pothole, autonomous driving of the vehicle.

### CROSS-REFERENCE TO RELATED APPLICATION

This application claims the benefit of priority to Korean Patent Application No. 10-2024-0171923, filed in the Korean Intellectual Property Office on Nov. 27, 2024, the entire contents of which are incorporated herein by reference.

### TECHNICAL FIELD

Examples relate to a vehicle control device and method.

### BACKGROUND

The matters described in this Background section are only for enhancement of understanding of the background of the disclosure, and should not be taken as acknowledgment that they correspond to prior art already known to those skilled in the art.

Potholes appearing in the road may pose a serious threat to driver safety, and may be an even greater threat for autonomous vehicles because it is difficult to flexibly respond to potholes.

Some autonomous driving technologies may respond only to obstacles capable of being recognized, and may not have a reporting system for potholes. The size and depth of potholes on the road may vary greatly, making it difficult to identify and respond to potholes utilizing camera, lidar, or radar recognition technology.

### SUMMARY

According to the present disclosure, an apparatus of a vehicle, the apparatus comprising, one or more processors, and a memory storing one or more programs that, when executed by the one or more processors communicating with the memory, are configured to cause the apparatus to, estimate, based on a driving image of a preceding vehicle captured by a camera of the vehicle, a roll rate of the preceding vehicle, determine a possibility of a pothole avoidance, wherein the possibility is determined based on the roll rate of the preceding vehicle, driving information about the preceding vehicle, and driving information about the vehicle, output a signal indicating the possibility, and control, based on the signal and based on an estimated pothole, autonomous driving of the vehicle.

The apparatus, wherein the one or more programs, when executed by the one or more processors, are configured to cause the apparatus to, identify, based on the driving image, a center line of the preceding vehicle, and estimate a first roll rate based on an angle change amount of the center line for each frame associated with the driving image of the preceding vehicle, and wherein the roll rate of the preceding vehicle comprises the first roll rate.

The apparatus, wherein the one or more programs, when executed by the one or more processors, are configured to cause the apparatus to estimate a second roll rate based on a yaw rate of the preceding vehicle and a speed of the preceding vehicle, and wherein the roll rate of the preceding vehicle further comprises the second roll rate.

The apparatus, wherein the one or more programs, when executed by the one or more processors, are configured to cause the apparatus to determine a lane change strategy based on the possibility being greater than or equal to a preset reference probability value.

The apparatus, wherein the one or more programs, when executed by the one or more processors, are configured to cause the apparatus to determine the possibility based on, a difference value between the first roll rate and the second roll rate, a speed of the vehicle, the speed of the preceding vehicle, a roll rate of the vehicle, and a steering angle of the vehicle.

The apparatus, wherein the one or more programs, when executed by the one or more processors, are configured to cause the apparatus to determine the possibility by inputting a plurality of input values into a trained learning model, and wherein the plurality of input values comprises at least two of, the first roll rate, the second roll rate, the difference value between the first roll rate and the second roll rate, the speed of the preceding vehicle, the speed of the vehicle, the roll rate of the vehicle, and the steering angle of the vehicle.

The apparatus, wherein the one or more programs, when executed by the one or more processors, are configured to cause the apparatus to determine a lane change strategy and a deflected driving strategy based on the possibility being less than a preset reference probability value.

The apparatus, wherein the one or more programs, when executed by the one or more processors, are configured to cause the apparatus to determine a preceding vehicle following strategy based on the first roll rate being less than a preset first reference value.

The apparatus, wherein the one or more programs, when executed by the one or more processors, are configured to cause the apparatus to determine a lane change strategy or a lane line crossing strategy based on a difference value between the first roll rate and the second roll rate being less than a preset second reference value.

The apparatus, wherein the one or more programs, when executed by the one or more processors, are configured to cause the apparatus to determine the lane change strategy and a deflected driving strategy based on the possibility and based on the difference value between the first roll rate and the second roll rate being greater than or equal to the preset second reference value.

According to the present disclosure, a method performed by an apparatus of a vehicle, the method comprising, estimating, based on a driving image of a preceding vehicle captured by a camera of the vehicle, a roll rate of the preceding vehicle, determining a possibility of a pothole avoidance, wherein the possibility is determined based on the roll rate of the preceding vehicle, driving information about the preceding vehicle, and driving information about the vehicle, outputting a signal indicating the possibility, and controlling, based on the signal and based on an estimated pothole, autonomous driving of the vehicle.

The method, wherein the estimating of the roll rate comprises, identifying, based on the driving image, a center line of the preceding vehicle, and estimating a first roll rate based on an angle change amount of the center line for each frame associated with the driving image of the preceding vehicle, and wherein the roll rate of the preceding vehicle comprises the first roll rate.

The method, wherein the estimating of the roll rate further comprises estimating a second roll rate based on a yaw rate of the preceding vehicle and a speed of the preceding vehicle, and wherein the roll rate of the preceding vehicle further comprises the second roll rate.

The method, wherein the outputting of the signal comprises establishing a lane change strategy based on the possibility being greater than or equal to a preset reference probability value.

The method, wherein the determining of the possibility comprises determining the possibility based on, a difference value between the first roll rate and the second roll rate, a speed of the vehicle, the speed of the preceding vehicle, a roll rate of the vehicle, and a steering angle of the vehicle.

The method, wherein the determining of the possibility comprises determining the possibility by inputting a plurality of input values into a trained learning model, and wherein the plurality of input values comprises at least two of, the first roll rate, the second roll rate, the difference value between the first roll rate and the second roll rate, the speed of the preceding vehicle, the speed of the vehicle, the roll rate of the vehicle, and the steering angle of the vehicle.

The method, wherein the outputting of the signal comprises establishing a lane change strategy and a deflected driving strategy based on the possibility being less than a preset reference probability value.

The method, wherein the outputting of the signal comprises establishing a preceding vehicle following strategy based on the first roll rate being less than a preset first reference value.

According to the present disclosure, an apparatus of a vehicle, the apparatus comprising, a processor, and a memory storing at least one instruction that, when executed by the processor communicating with the memory, is configured to cause the apparatus to, estimate a first roll rate of a preceding vehicle based on image data associated with the preceding vehicle obtained from a camera of the vehicle, estimate a second roll rate of the preceding vehicle based on motion information associated with the preceding vehicle, determine, based on the first roll rate and the second roll rate, a likelihood that the preceding vehicle encountered a road surface anomaly, output a signal indicating the likelihood, and control, based on the signal, autonomous driving of the vehicle.

The apparatus, wherein, the image data indicates a center line inclination of the preceding vehicle in successive image frames, the motion information comprises at least a yaw rate of the preceding vehicle and a speed of the preceding vehicle, and the motion information is obtained by vehicle-to-vehicle communication with the preceding vehicle or obtained by a radar of the vehicle.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of a vehicle transmitting and receiving data by communicating with another device;

FIG. 2 shows an example of modules constituting a vehicle according to one example of the present disclosure;

FIG. 3 shows an exemplary operation of a processor;

FIG. 4 shows an exemplary operation of a first processing unit;

FIG. 5, FIG. 6, and FIG. 7 show an exemplary operation of a fourth processing unit; and

FIG. 8 shows an example of a method of controlling a vehicle.

### DETAILED DESCRIPTION

Hereinafter, preferred examples of the present disclosure will be described in detail with reference to the accompanying drawings.

However, the technical idea of the present disclosure is not limited to some examples to be described but may be implemented in various different forms, and within the scope of the technical idea of the present disclosure, one or more among components in the examples may be used by being selectively combined and substituted.

Further, unless specifically defined and described, terms used in the examples of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning of the related art.

The terms used in the examples of the present disclosure are for the purpose of describing the examples only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, when describing components of examples of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. If the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure. An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of determining a likelihood of an upcoming road anomaly, for example, like a pothole) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of determining a likelihood of an upcoming road anomaly, for example, like a pothole) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of determining a likelihood of an upcoming road anomaly, for example, like a pothole) described herein.

Minimum risk maneuver (MRM) operation(s) may also be controlled, for example, based on one or more features (e.g., features of determining a likelihood of an upcoming road anomaly, for example, like a pothole) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of determining a likelihood of an upcoming road anomaly, for example, like a pothole) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of determining a likelihood of an upcoming road anomaly, for example, like a pothole) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

Hereinafter, examples will be described in detail with reference to the accompanying drawings, but the same or corresponding components are denoted by the same reference numerals regardless of the drawing numbers, and redundant descriptions thereof will be omitted.

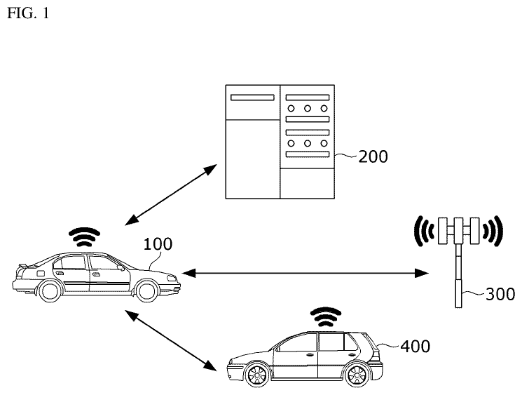

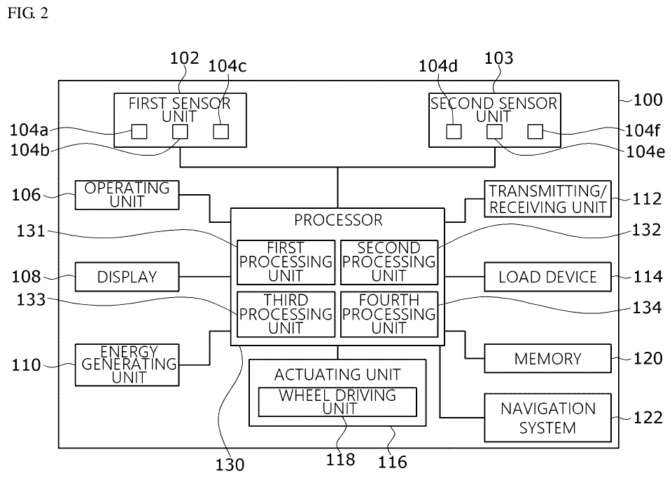

Hereinafter, a vehicle will be described with reference to FIGS. 1 and 2. FIG. 1 shows an example of a vehicle transmitting and receiving data by communicating with another device.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy (e.g., hydrogen, methane, ammonia, or natural gas, etc.), and the vehicle 100 may be filled with gas in a liquefied state, for example. Here, one example of the gas may be hydrogen. However, the gas is not limited thereto, and various gases are applicable. In the case of fossil energy, the vehicle 100 is driven based on fuel such as gasoline, diesel or liquefied gas (e.g., LPG, CNG, kerosene, or bunker fuel, etc.), and may be equipped with an internal combustion engine that drives an actuating unit 116 by combustion of the fuel. The engine may be included in an energy generating unit 110 for providing a driving rotational force to wheels through a wheel driving unit 118. As another example, the vehicle 100 may drive the actuating unit 116 by selectively utilizing energy from a fossil energy-based internal combustion engine and an electric battery, and may be a hybrid type vehicle (e.g., a parallel hybrid, series hybrid, plug-in hybrid, or mild hybrid, etc.).

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, an agricultural vehicle, or a military transport vehicle, etc. Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules (e.g., legs, rollers, or sled-based mechanisms, etc.). In the present disclosure, ground mobility devices such as ground vehicles are mainly described, but unless it contradicts the present disclosure, the present example may also be applied to air mobility devices such as AAMs, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even if a driving situation is uncertain (e.g., during poor weather conditions, complex urban environments, or sudden obstacle appearances, etc.). Semi-autonomous driving may be provided as autonomous movement that requires driver intervention depending on specific driving situations (e.g., construction zones, emergency vehicle encounters, complex intersections, or sensor failures, etc.). The semi-autonomous driving may be implemented so that the processor 130 transfers control to a user by deactivating autonomous driving if the aforementioned situation occurs, allowing the user to perform manual driving (e.g., by re-engaging the steering wheel, pressing the brake pedal, or responding to a takeover request, etc.). According to the levels of autonomous driving defined by the Society of Automotive Engineers (SAE), the semi-autonomous driving may correspond to autonomous driving levels 1 to 4, and the fully autonomous driving may correspond to level 5 (e.g., Level 1: driver assistance, Level 2: partial automation, Level 3: conditional automation, Level 4: high automation, or Level 5: full automation, etc.).

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, (e.g., smartphones, tablets, wearable devices, or onboard infotainment systems, etc.), or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100 (e.g., route optimization, traffic updates, or remote diagnostics, etc.).

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, traffic signal information, or weather conditions, etc., through vehicle-to-infrastructure (V2I) communication with the vehicle 100. The vehicle 100 may support manual driving or autonomous driving by exchanging the data listed above through vehicle-to-vehicle (V2V) communication with the other vehicle 400 (e.g., for collision avoidance, platooning, or cooperative lane changing, etc.).

The vehicle 100 may communicate with other vehicles or other devices based on cellular communication, wireless access in vehicular environment (WAVE) communication, dedicated short range communication (DSRC), short-range communication, or other communication methods (e.g., Bluetooth, ultra-wideband (UWB), or satellite communication, etc.).

For example, the vehicle 100 may use a cellular communication network such as LTE or 5G, a WiFi communication network, a WAVE communication network, or the like (e.g., IEEE 802.11p, C-V2X, or mmWave, etc.), for communication with the server 200, the ITS device 300, and the other vehicle 400. For another example, DSRC or the like used in the vehicle 100 may be used for communication between vehicles (e.g., for exchanging location, speed, or hazard warning information, etc.). The communication method between the vehicle 100, the server 200, the ITS device 300, the other vehicle 400, and the user device is not limited to the above-described example and may include other wired or wireless technologies depending on system configuration or infrastructure availability.

FIG. 2 shows an example of modules constituting a vehicle according to one example of the present disclosure;

The vehicle 100 may include a sensor unit 102, an operating unit 106, a display 108, a load device 114, and a transmitting/receiving unit 112.

The sensor unit 102 may be provided with various types of detectors to detect various states and situations occurring in an external environment, an internal system, user operation, and a boarding space of the vehicle 100 (e.g., cabin temperature, passenger presence, or door status, etc.).

Specifically, the first sensor unit 102 may be provided with an externally oriented camera 104a, a lidar sensor 104b, a radar sensor 104c, and the like, to recognize dynamic and static objects present outside the vehicle 100. The camera 104a may recognize an external object as an image while the vehicle 100 is in use, generate image data, and transmit the image data to the processor 130 (e.g., for object classification, lane detection, or pedestrian recognition, etc.). The lidar sensor 104b may generate point cloud data as recognized data of the external object and transmit the point cloud data to the processor 130 to generate 3D spatial information that identifies at least a shape of the external object (e.g., a vehicle, building, or traffic barrier, etc.). In order to ascertain the presence of an external object and its relative distance, speed, direction, or the like, the radar sensor 104c may emit radio waves of a specific frequency around the vehicle 100 and generate radar data through radio waves reflected from the external object (e.g., approaching vehicles, bicycles, or road obstacles, etc.). In the present disclosure, the sensor unit is shown as having the lidar sensor 104b, but in other examples, the lidar sensor 104b may not be mounted depending on cost, platform configuration, or specific use cases.

The first sensor unit 102 may generate object recognition information based on sensing data. The object recognition information may include information on the presence of an object, position information about the object, information on a distance between the vehicle 100 and the object, and information on a relative speed between the vehicle 100 and the object (e.g., approaching rate, collision risk, or safe following distance, etc.). In the example, external objects may be various objects related to the operation of the vehicle 100 (e.g., other vehicles, traffic signs, pedestrians, bicycles, or animals, etc.).

A second sensor unit 103 may be provided with a positioning sensor 104d, a wheel sensor 104e, an attitude sensor 104f, and the like, to confirm its own location, speed, driving attitude, and the like (e.g., inclination, stability, or heading direction, etc.). The attitude sensor 104f may include a gyro sensor, an angular velocity sensor, an acceleration sensor, or the like (e.g., magnetometer, tilt sensor, or vibration sensor, etc.). The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and yaw, pitch, and roll angles as the angular velocity of the vehicle, for example, for real-time orientation tracking and maneuver stability analysis.

The second sensor unit 103 may generate vehicle driving information based on sensing data. The vehicle driving information may be information generated based on data detected by various sensors installed inside the vehicle (e.g., in the chassis, drivetrain, or cabin, etc.). For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like (e.g., brake status, transmission state, or energy regeneration rate, etc.).

In addition, the vehicle driving information may include route information. The route information may refer to information generated based on a destination input by a vehicle user through the operating unit 106. The route information may refer to information that indicates a traveling route from a current vehicle position to a destination on a map if the destination has been set (e.g., shortest route, fuel-efficient route, scenic route, or toll-free route, etc.). If no destination is set, the route information may refer to information including a road on which a host vehicle is currently traveling and a future driving route including the road (e.g., based on habitual driving patterns or real-time navigation suggestions, etc.).

The operating unit 106 may be configured as a module that is controlled by the user for driving. For example, the operating unit 106 may be a steering wheel for manual driving, an automatic or manual shift transmission, an accelerator pedal, a brake pedal, or the like (e.g., clutch pedal, gear selector knob, or drive mode selector, etc.). The operating unit 106 may be further provided with an interface for enabling or disabling an autonomous driving mode and selecting detailed functions requested by the user so that the user may use an autonomous driving function (e.g., lane keeping assist, adaptive cruise control, or auto-parking, etc.). In order to receive various requests related to autonomous driving, the operating unit 106 may be configured, for example, as a hard-type interface provided at a predetermined position inside the vehicle 100, or as a soft-type interface that can be touched on the display 108 (e.g., a virtual button, gesture control panel, or haptic interface, etc.). Depending on the specifications of the autonomous vehicle, at least one of the steering wheel, the transmission, and the pedal may be omitted (e.g., in full self-driving shuttles or remote-controlled vehicles, etc.). For another example, the operating unit 106 may be provided with a module that receives a user's control request for the load device 114 in addition to driving control (e.g., to adjust cabin lighting, HVAC settings, or multimedia playback, etc.).

The display 108 may function as a user interface. The display 108 may output and display an operating state, a control state, route/traffic information, remaining energy amount information, content requested by the driver, or the like, of the vehicle 100 by the processor 130 (e.g., real-time diagnostics, driver alerts, or service reminders, etc.). In addition, the display 108 may be configured as a touch screen capable of detecting a driver's input to receive a driver's request to instruct the processor 130 (e.g., for navigation input, climate control adjustment, or media selection, etc.).

The load device 114 is mounted on the vehicle 100 and may be a type of non-driving electrical device excluding a driving power system such as the wheel driving unit 118 or the like. The load device 114 is an auxiliary device that receives electrical power from the energy generating unit 110, and may be, for example, an air conditioning system, a lighting system, a seat system, various devices installed in the vehicle 100, or the like (e.g., infotainment circuit, power window motor, or wireless charging pad, etc.). In the present disclosure, a cooling/heating system that cools or heats at least one of a battery, a fuel cell, an internal combustion engine, an air conditioning system, and a specific part of the vehicle 100 may be further included (e.g., thermal management for battery efficiency or cabin pre-conditioning, etc.).

The transmitting/receiving unit 112 may support mutual communication with the server 200, the ITS device 300, surrounding vehicles 300, and the like (e.g., cloud services, smart infrastructure, or peer vehicles in cooperative systems, etc.). The transmitting/receiving unit 112 may include a module that processes, for example, cellular communication, WAVE, DSRC communication, and the like (e.g., WiFi, Bluetooth, or ultra-wideband, etc.). In the present disclosure, the transmitting/receiving unit 112 may transmit data generated or stored while driving to the server 200 and receive data and software modules transmitted from the server 200 (e.g., firmware updates, HD maps, or traffic data, etc.). The transmitting/receiving unit 112 may support communication with an electronic device carried by an occupant inside the vehicle 100 (e.g., a smartphone, smartwatch, or tablet, etc.). In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130 (e.g., green light timing, pedestrian crossing status, or adaptive signal phase updates, etc.). In addition, the transmitting/receiving unit 112 may receive a control signal from the traffic signal controller and provide the control signal to the processor 130 (e.g., for vehicle prioritization, emergency routing, or signal override in special conditions, etc.).

In the example, the operating unit 106, the display 108, and the transmitting/receiving unit 112 may constitute audio, video, navigation, telecommunication (AVNT) 150 (e.g., infotainment control, media playback, real-time traffic navigation, or wireless connectivity services, etc.).

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions (e.g., cabin lighting, HVAC, or seat position memory, etc.), excluding components directly involved in driving operations. When the vehicle 100 is driven based on electrical energy, the energy generating unit 110 may be configured as an electric battery charged from the outside (e.g., through a home charger, public fast charger, or solar panel system, etc.), or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen (or alternative fuels like methanol or ammonia, etc.). When the vehicle 100 is driven based on fossil energy, the energy generating unit 110 may be configured as an internal combustion engine (e.g., gasoline engine, diesel engine, or turbocharged variant, etc.). In addition, when the vehicle 100 is a hybrid type, the energy generating unit 110 may be provided as a combination of the internal combustion engine and the electric battery (e.g., in parallel hybrid, series hybrid, or plug-in hybrid configurations, etc.).

The actuating unit 116 may be provided with at least one module that implements driving operations and perform at least one driving operation among longitudinal control such as acceleration and deceleration and lateral control such as steering, according to a user request from the operating unit 106 (e.g., via pedal input, steering rotation, or cruise control activation, etc.). In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118 (e.g., electric motor controller, inverter, or reduction gear, etc.). When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine (e.g., automatic gearbox, continuously variable transmission (CVT), or dual-clutch system, etc.).

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels (e.g., during cornering, lane changes, or obstacle avoidance, etc.). When the vehicle 100 is driven based on electrical energy, the driving force generating module may be configured as a motor assembly that generates a driving force based on electric power output from the electric battery (e.g., AC induction motor, permanent magnet synchronous motor, or axial flux motor, etc.). The braking module of the electric-based vehicle 100 may further have a regenerative braking function to convert kinetic energy into electrical energy and recharge the battery during deceleration or downhill driving.

A navigation unit 122 may provide navigation information. The navigation information may include at least one of map information, set destination information, route information according to a set destination, information on various objects on the route, lane information, and current vehicle position information (e.g., obtained from GNSS, dead reckoning, or sensor fusion, etc.).

The navigation unit 122 may receive information from an external device through the transmitting/receiving unit 112 and update previously stored information (e.g., real-time traffic updates, construction zones, or road closures, etc.). According to the example, the navigation unit 122 may be classified as a sub-component of the operating unit 106 and may be integrated with the display 108 or voice assistant system for driver convenience.

In addition, the vehicle 100 may include a memory 120 and the processor 130.

The memory 120 may store applications and various types of data for controlling the vehicle 100, and load applications or read and record data by a request of the processor 130 (e.g., driving preferences, route history, or AI model weights, etc.).

The processor 130 may perform overall control of the vehicle 100. The processor 130 may be configured to execute applications and instructions stored in the memory 120 to manage perception, decision-making, control tasks, and communication with external systems.

The processor 130 may include a first processing unit 131, a second processing unit 132, a third processing unit 133, and a fourth processing unit 134, for example, each dedicated to specific autonomous driving functions such as perception, estimation, planning, and control, respectively.

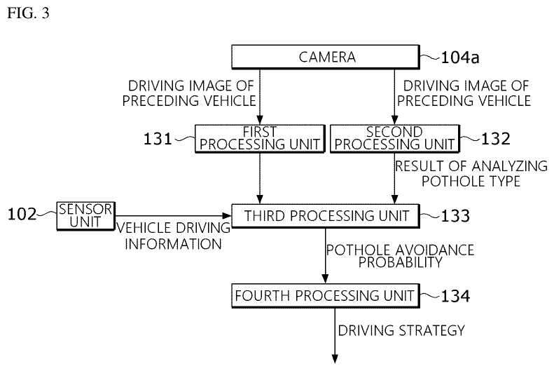

FIG. 3 shows an exemplary operation of the processor. Referring to FIG. 3, the first processing unit 131 may determine a first roll rate of a preceding vehicle using a driving image of the preceding vehicle captured by the camera 104a. For example, the first processing unit 131 may calculate a center line of the preceding vehicle from the driving image and determine the first roll rate using an angle change amount of the center line for each frame (e.g., by applying frame-by-frame image analysis and motion estimation techniques). For example, the first processing unit 131 may determine the first roll rate using the driving image of the preceding vehicle located within 20 meters ahead to detect sudden rolling behavior indicative of road surface anomalies such as potholes or uneven surfaces.

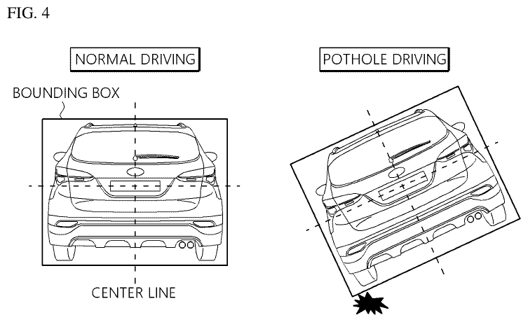

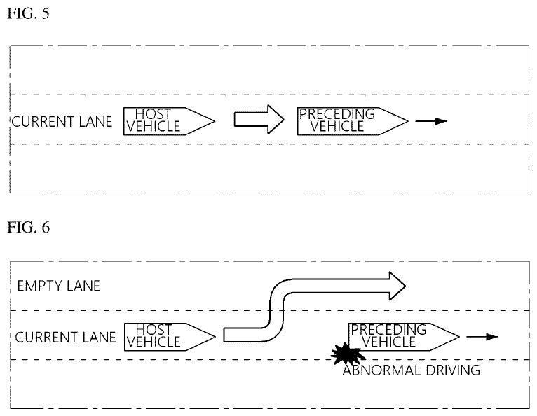

FIG. 4 shows an exemplary operation of the first processing unit. Referring to FIG. 4, the first processing unit 131 may detect a driving image of a preceding vehicle with a bounding box for each frame and calculate a roll rate by tracking a change in inclination of a center line of the box. This process may include a process of measuring a left-right inclination change rate of the preceding vehicle in real time and analyzing a dynamic behavior (roll motion) of the preceding vehicle by utilizing computer vision and image processing technologies (e.g., optical flow tracking, frame differencing, or pose estimation, etc.).

In the example, the roll rate is the angular velocity at which the vehicle tilts left or right, and a large value may occur during sharp turning or abnormal cornering or if the vehicle passes over a pothole, a speed bump, or an uneven road surface, etc.

In the example, the bounding box may refer to a rectangular bounding box that surrounds an object, and through the bounding box, the position and posture of the preceding vehicle may be determined (e.g., orientation, tilt angle, or lane alignment, etc.).

In the example, the inclination of the box center line is changed as a vertical axis (center line) of the bounding box is inclined according to the inclination of the preceding vehicle, and this change is for estimating the roll rate, for example, based on visual deviations that correspond to physical tilt or lean of the vehicle body.

The first processing unit 131 may detect the preceding vehicle in the driving image and generate the bounding box using an object detection algorithm such as YOLO, Faster R-CNN, or the like (e.g., SSD, RetinaNet, or EfficientDet, etc.). The bounding box may be a rectangular boundary that surrounds a vehicle, and may provide center and boundary point coordinates that are used for further geometric transformations and motion tracking.

The first processing unit 131 may calculate the inclination of the preceding vehicle based on the vertical center line of the bounding box. The angle of a center line may be measured as an inclination (angle) with respect to a vertical line in the image coordinate space, indicating the vehicle's lean.

The first processing unit 131 may calculate the inclination of the center line of the bounding box for each frame of the image. In addition, the first processing unit 131 may calculate an inclination change rate through an inclination difference between the frames, for example, to detect abrupt rotational shifts associated with dynamic vehicle behavior. The first processing unit 131 may calculate the first roll rate by dividing the inclination change rate by time. In this case, the first processing unit 131 may stabilize the inclination change using a Kalman filter or a moving average filter (or similar smoothing algorithms such as Gaussian filters or exponential smoothing, etc.) to remove noise.

The first processing unit 131 may determine that an abnormal movement of the preceding vehicle (e.g., rapid cornering, risk of rollover) has occurred if the first roll rate exceeds a threshold value (e.g., 2.5 deg/s or higher, depending on vehicle speed and road context, etc.).

In this way, the roll rate of the preceding vehicle may be detected and information for performing emergency braking or an emergency route change in a dangerous situation may be provided to enhance vehicle safety and stability in real time.

The second processing unit 132 may determine a yaw rate and a second roll rate of the preceding vehicle using the driving image. For example, the second processing unit 132 may determine the second roll rate based on the yaw rate of the preceding vehicle and the speed of the preceding vehicle (e.g., through kinematic estimation or a physics-based motion model, etc.).

In vehicle dynamics models, the yaw rate and the roll rate are closely related. In particular, when the vehicle turns, as a lateral acceleration of the vehicle increases, rolling that causes the body of the vehicle to tilt left and right occurs, and in this case, the roll rate indicates the inclination change rate of the vehicle, for example, due to side forces acting on the suspension system. The second processing unit 132 may use a bicycle model and a roll plane model to determine a relationship between the yaw rate and the roll rate, for example, by simplifying the vehicle into a two-wheel analog for easier calculation of dynamic behavior.

The yaw rate is an angular velocity at which the vehicle rotates around a vertical axis, and large values are mainly measured during steering operations by simplifying the vehicle into a two-wheel analog for easier calculation of dynamic behavior.

The lateral acceleration is an acceleration that the vehicle experiences due to centrifugal force when the vehicle is turning, and may be measured by the sensor unit (e.g., an IMU, accelerometer, or cornering G-force sensor, etc.).

The longitudinal speed of the vehicle affects the overall rotational dynamics of the vehicle along with the yaw rate, for example, by influencing both the magnitude and response time of the roll and yaw behavior.

The bicycle model is a simplified model of the vehicle constituted by front wheel and rear wheel axles, and may describe rotational behavior. This model is used to determine the lateral acceleration and the roll rate based on the steering and yaw rate of the vehicle and is commonly applied in vehicle stability control and simulation systems.

The second processing unit 132 may calculate the yaw rate of the preceding vehicle using a rotational angular velocity of a vehicle located in front of the host vehicle. The rotational angular velocity of the preceding vehicle may be detected through a radar or LiDAR of the sensor unit, or obtained through vehicle-to-vehicle (V2V) communication with the preceding vehicle (e.g., via basic safety messages or cooperative awareness messages, etc.).

The second processing unit 132 may determine the roll rate based on a relationship between the yaw rate and the lateral acceleration. In this case, the conversion from the yaw rate to the roll rate may be performed using the bicycle model and an approximated roll plane model, which may incorporate suspension stiffness, mass distribution, and gravitational effects.

For example, the second processing unit 132 may determine the relationship between a yaw rate r and a roll rate φ·(s) according to the following Equation 1.

$$\begin{matrix}\frac{\dot{ϕ}}{r} ( s ) = \frac{\dot{ϕ}}{{a}_{y}} ( s ) \cdot \frac{{a}_{y}}{r} ( s ) = \frac{{n}_{1} {s}^{3} + {n}_{2} {s}^{2} + {n}_{3} s + {n}_{4}}{{d}_{1} {s}^{3} + {d}_{2} {s}^{2} + {d}_{3} s + {d}_{4}} \\ where \\ {n}_{1} = {h}_{cr} {m}_{s} {I}_{z} {V}_{x} \\ {n}_{2} = {h}_{cr} {m}_{s} [ {C}_{r} c ( b + c ) ] \\ {n}_{3} = {h}_{cr} {m}_{s} [ {C}_{r} {V}_{x} ( b + c ) ] \\ {d}_{1} = {I}_{x} {mV}_{x} b \\ {d}_{2} = {I}_{x} {C}_{r} ( b + c ) + {C}_{ϕ} {mV}_{x} b \\ {d}_{3} = m {V}_{x} b ( - {gh}_{cr} {m}_{s} + {K}_{ϕ} ) + {C}_{ϕ} {C}_{r} ( b + c ) \\ {d}_{4} = ( - {gh}_{cr} {m}_{s} + {K}_{ϕ} ) [ {C}_{r} ( b + c ) ]\end{matrix}$$

Equation 1 may describe a process of estimating the roll rate φ·(s) of the preceding vehicle from the dynamic variables of the host vehicle. Here, each of the coefficients n₁, n₂, n₃, and n₄ and d₁, d₂, d₃, and d₄ may be defined according to the dynamic characteristics of the vehicle (e.g., structural layout, suspension setup, or mass distribution, etc.).

n₁ represents the effect of a position of a center of gravity of the vehicle and the speed of the vehicle on the roll motion, h_{cr} is a vertical distance from the center of gravity CG to a roll axis, mₛ is a sprung mass (mass above the suspension), I_{z} is a moment of inertia about the vertical axis, and Vₓ is the longitudinal velocity of the vehicle (measurable through wheel sensors or GPS speed estimators, etc.).

n₂ represents the effect of tire stiffness on the roll motion, Cᵣ is the lateral stiffness of the tire, and b and c are distances between front and rear axles of the vehicle and the center of gravity CG, respectively (influencing the vehicle's cornering characteristics and weight transfer).

n₃ represents the combined effect of vehicle speed and tire stiffness, and n₄ represents an offset to the roll rate caused by a constant external force or suspension characteristics (e.g., crosswinds, banking angles, or load asymmetries, etc.).

d₁ represents the combined effect of the roll inertia and speed of the vehicle on roll behavior, Iₓ is a moment of inertia about the roll axis, and b is the distance between the front axle and the center of gravity CG (affecting the responsiveness and stability of roll dynamics).

d₂ represents the effect of tire and suspension stiffness on roll behavior, and Cφ is the vehicle's roll stiffness (determined by anti-roll bars, spring rates, or active suspension systems, etc.).

d₃ and d₄ represent the mass and gravity effects of the vehicle (e.g., gravitational torque acting on the vehicle body during lateral loading).

The yaw rate rrr and the lateral acceleration aya_yay describes the dynamic behavior of the vehicle when cornering, and the relationship between the two may be used to predict the roll rate of the vehicle, for example, to anticipate body roll and ensure safer trajectory planning.

The second processing unit 132 may convert time domain signals into Laplace domain (s-domain) signals and process various differential operations, for example, to simplify transfer function modeling and frequency domain analysis for real-time estimation. Each coefficient in the numerator and denominator reflects dynamic characteristics such as the speed of the vehicle, the tire stiffness, the moment of inertia, and the like that collectively influence the roll behavior under dynamic conditions.

The second processing unit 132 may determine the second roll rate of the preceding vehicle based on the yaw rate of the preceding vehicle and the dynamic data of the host vehicle through a model according to Equation 1, for example, to estimate how the preceding vehicle physically responds to road disturbances such as potholes or uneven terrain.

The third processing unit 133 may determine the pothole avoidance possibility using the driving information about the preceding vehicle including the first roll rate and the second roll rate and the driving information about the host vehicle (e.g., current speed, roll rate, and steering angle of the host vehicle, etc.).

In the example, the pothole avoidance possibility may refer to a value obtained by probabilistically calculating the need for the host vehicle to avoid a pothole according to a probability that a pothole occurs at a position of the preceding vehicle and a risk level thereof (e.g., severity of detected roll behavior, road type, or proximity to lane boundaries, etc.).

The third processing unit 133 may determine a risk level of the pothole from the behavior of the preceding vehicle determined according to the first roll rate and the second roll rate, and may probabilistically calculate the need to avoid the pothole by combining driving information about the preceding vehicle and driving information about the host vehicle (e.g., dynamic context, vehicle state, and lane constraints).

The third processing unit 133 may compare a value of the first roll rate with a value of the second roll rate if the value of the first roll rate exceeds a preset first reference value, calculate a difference value, and calculate the pothole avoidance possibility based on the difference value (which may quantify the discrepancy between camera-based and model-based behavior estimation). The fourth processing unit 134 may determine that there is no abnormal behavior in the preceding vehicle if the value of the first roll rate is equal to or lower than the first reference value, and establish a strategy for following the preceding vehicle (e.g., maintaining speed and lane position).

If the value of the first roll rate exceeds a preset value, the third processing unit 133 may first determine that an abnormal behavior has occurred in the preceding vehicle, compare the difference value between the value of the first roll rate and the value of the second roll rate with a second reference value, and calculate the pothole avoidance possibility (e.g., using a threshold-based rule or by feeding it into a trained inference model).

For example, the third processing unit 133 may probabilistically calculate the pothole avoidance possibility using the first roll rate, the second roll rate, the difference value between the first roll rate and the second roll rate, the speed of the preceding vehicle, the speed of the host vehicle, the roll rate of the host vehicle, and the steering angle of the host vehicle (e.g., as a multi-dimensional feature vector for risk prediction using statistical or machine learning-based models).

A sudden change of the roll rate of the preceding vehicle indicates a possibility of contact with an obstacle (pothole), and the speed of the preceding vehicle reflects the possibility that an impact from the pothole becomes larger at higher speed (e.g., due to reduced reaction time and amplified suspension dynamics). The speed of the host vehicle reflects that the difficulty of the avoidance operation increases as the driving speed of the host vehicle increases, and the roll rate of the host vehicle means that pothole avoidance may become more difficult when the vehicle is already rolling (e.g., during a lane change or evasive maneuver). In addition, when the steering angle of the host vehicle drastically changes, it means the avoidance operation by which the host vehicle avoids the pothole (e.g., through quick lateral deviation or trajectory adjustment).

If the difference value between the first roll rate and the second roll rate is less than the preset second reference value, the third processing unit 133 may calculate an average value of values of the first roll rate and the second roll rate and calculate the pothole avoidance possibility based on the average value (e.g., to smooth out minor discrepancies between camera-based and model-based estimations). The third processing unit 133 may compare the roll rate reference value set according to the speed of the host vehicle with the average value of the values of the first roll rate and the second roll rate and calculate the pothole avoidance possibility (e.g., using a lookup table or speed-adaptive thresholding strategy). The third processing unit 133 may determine that the behavior of the preceding vehicle is greatly affected by the pothole if the average value is greater than the reference value and calculate the pothole avoidance possibility as high (e.g., indicating urgent need for evasive maneuvering). Alternatively, the third processing unit may determine that the behavior of the preceding vehicle is minimally affected by the pothole if the average value is smaller than the reference value and calculate the pothole avoidance possibility as low (e.g., allowing continued lane following without deviation).

The third processing unit 133 may calculate the pothole avoidance possibility according to the value of the roll rate having a greater value if the difference value between the first roll rate and the second roll rate is greater than or equal to the preset second reference value (e.g., suggesting significant estimation divergence due to real anomalies or sensor misalignment). The third processing unit 133 may compare the roll rate reference value set according to the speed of the host vehicle with the value of the first roll rate or the second roll rate value and calculate the pothole avoidance possibility, for example, by treating the dominant roll signal as the primary indicator of abnormal behavior. The third processing unit 133 may determine that the behavior of the preceding vehicle is greatly affected by the pothole if the value of the first roll rate or second roll rate is greater than the reference value and calculate the pothole avoidance possibility as high (e.g., triggering a lane change or deflected path generation). Alternatively, the third processing unit may determine that the behavior of the preceding vehicle is minimally affected by the pothole if the value of the first roll rate or the second roll rate is lower than the reference value and calculate the pothole avoidance possibility as low (e.g., continuing in the current trajectory without adjustment).

Alternatively, the third processing unit 133 may calculate the pothole avoidance possibility through a learning model trained to calculate the pothole avoidance possibility using the first roll rate, the second roll rate, the difference value between the first roll rate and the second roll rate, the speed of the preceding vehicle, the speed of the host vehicle, the roll rate of the host vehicle, and the steering angle of the host vehicle as inputs if the difference value between the first roll rate and the second roll rate is greater than or equal to the preset second reference value (e.g., indicating potential inconsistency or unmodeled dynamics requiring data-driven evaluation).

The third processing unit 133 may extract features of given data and learn spatiotemporal patterns of the data by inputting the first roll rate, the second roll rate, the difference value between the first roll rate and the second roll rate, the speed of the preceding vehicle, the speed of the host vehicle, the roll rate of the host vehicle, and the steering angle of the host vehicle into a skip-connected convolutional neural network (CNN) as training data (e.g., for spatial feature extraction from multi-sensor sequences). Low-dimensional features extracted through the CNN may be transferred to a long short-term memory (LSTM) layer. The LSTM may be suitable for handling sequential data or time series data, and may perform learning considering temporal dependence (e.g., capturing transitions in behavior over time or identifying emerging risk patterns). In this process, the LSTM learns a time-series correlation between pieces of input data to more accurately identify the dynamic relationship between the preceding vehicle and the host vehicle (e.g., how abnormal motion propagates and affects following vehicles). Finally, the information learned by the LSTM is transferred to a fully connected layer, and in this layer, a final pothole avoidance possibility may be calculated (e.g., via a softmax or sigmoid activation depending on the risk classification architecture). The pothole avoidance possibility may include a risk probability (contingency) and the normal probability (nominal) to quantify the likelihood of requiring evasive maneuvers.

The probability of nominal (Pn) may refer to the probability that the host vehicle travels normally. This refers to a normal situation in which the movement between the host vehicle and the preceding vehicle is not dangerous (e.g., no sudden roll event, smooth path continuity, and no evasive adjustment required).

The probability of contingency (Pc) refers to a potentially dangerous situation that requires an avoidance operation. The higher this value, the more likely it is that the avoidance operation is required in interactions with a surrounding vehicle (e.g., sharp evasive steering, emergency braking, or trajectory adjustment due to a road hazard like a pothole, etc.).

The third processing unit 133 receives various pieces of state information about the host vehicle and the preceding vehicle as inputs through the learning model, learns patterns of time series data through the CNN-LSTM structure, and may probabilistically infer whether or not a situation requires the avoidance operation due to a pothole (e.g., based on spatiotemporal relationships and anomaly patterns in motion signals).

The fourth processing unit 134 may calculate a control strategy for the host vehicle based on the pothole avoidance possibility (e.g., to determine whether to follow, change lanes, or execute a partial deviation maneuver).

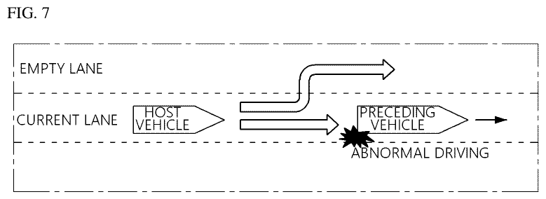

FIG. 5, FIG. 6, and FIG. 7 show an exemplary operation of the fourth processing unit.

Referring to FIG. 5, the fourth processing unit 134 may establish a preceding vehicle following strategy if the first roll rate is less than the preset first reference value. As described above, if the value of the first roll rate is equal to or less than the preset value, the fourth processing unit 134 may determine that there is no abnormal behavior in the preceding vehicle and establish a strategy for following the preceding vehicle (e.g., maintaining speed, trajectory, and safe distance).

The fourth processing unit 134 may establish a lane change strategy or a lane line crossing strategy if the difference value between the first roll rate and the second roll rate is less than the preset second reference value. If the difference value between the first roll rate and the second roll rate is less the preset second reference value, the fourth processing unit 134 may establish a lane change strategy, a preceding vehicle following strategy, or a deflected driving strategy according to the pothole avoidance possibility (e.g., using a rule-based policy or a threshold-triggered logic controller). The fourth processing unit 134 may establish the lane line crossing strategy if the pothole avoidance possibility is greater than or equal to a preset first reference probability and establish the preceding vehicle following strategy if the pothole avoidance possibility is equal to or less than a second reference probability. The fourth processing unit 134 may establish the deflected driving strategy if the pothole avoidance possibility is between the first reference probability and the second reference probability. In this case, the first reference probability may have a higher value than the second reference probability (e.g., first reference=0.85 and second reference=0.45, with the range between triggering a mid-level maneuver).

If the difference value between the first roll rate and the second roll rate is greater than or equal to the preset second reference value, the fourth processing unit 134 may establish the lane line crossing strategy and the deflected driving strategy according to the pothole avoidance possibility (e.g., applying more conservative or aggressive strategies based on the model's risk prediction output).

Referring to FIG. 6, the fourth processing unit 134 may establish the lane change strategy if the pothole avoidance possibility is greater than or equal to a preset reference probability (e.g., a high-risk threshold such as 0.8 indicating an urgent need to reroute). If the pothole avoidance possibility is greater than or equal to the reference probability, the fourth processing unit 134 may establish a strategy of changing lanes to another lane where a pothole does not occur without establishing the deflected driving strategy (e.g., if lane change is safer and more effective than localized deviation). That is, the fourth processing unit 134 may determine that the driving of the preceding vehicle is greatly affected by the pothole according to the driving information about the preceding vehicle and the driving information about the host vehicle and that it is not easy to avoid the pothole through deflected driving, and establish the pothole avoidance strategy through lane line crossing (e.g., full lateral maneuver across marked boundaries into an adjacent lane).

Referring to FIG. 7, if the pothole avoidance possibility is less than the reference probability, the fourth processing unit 134 may establish the lane change strategy and a deflected driving strategy based on the pothole avoidance possibility (e.g., if risk is moderate and multiple maneuver options are available). The fourth processing unit 134 may establish both the deflected driving strategy and the lane line crossing strategy if the pothole avoidance possibility is less than the reference probability. That is, in a situation where the driving of the preceding vehicle is greatly affected by the pothole according to the driving information about the preceding vehicle and the driving information about the host vehicle and it is possible to avoid the pothole by both deflected driving and lane changing, the fourth processing unit 134 may establish both pothole avoidance strategies (e.g., enabling real-time selection based on traffic, road width, or driver override inputs).

The fourth processing unit 134 may establish a driving strategy through the probability of contingency (Pc) and the probability of nominal (Pn) of the pothole. This strategy may be implemented based on multi-reference model predictive control (MPC) that modifies a driving route or optimizes steering and speed (e.g., predicting future vehicle states and selecting the safest trajectory while satisfying vehicle dynamics and road constraints).

The fourth processing unit 134 may set the cost incurred when the host vehicle travels along its driving lane and the cost incurred when the host vehicle travels through a lane change as an objective function, and then establish a driving strategy that may minimize the objective function according to the risk level of pothole (e.g., balancing safety, maneuver complexity, and vehicle dynamics constraints).

The fourth processing unit 134 prioritizes lane changes if the risk level of the pothole is high, and prioritizes deflected driving if the risk of collision is low, but also determines the possibility of lane changes through the distance, speed information, and the like (e.g., from V2V communication) of surrounding vehicles (e.g., available lateral gap, relative speed, or intended trajectory of adjacent vehicles). The fourth processing unit 134 establishes a strategy to avoid a pothole by changing lanes when lane changes are possible and the cost of the objective function is minimized or reduced (e.g., if risk reduction and driving efficiency are both satisfied). Alternatively, if lane line crossing is not possible, a strategy to perform deflected driving by adjusting the steering angle of the host vehicle is established (e.g., through minor lateral offset within the current lane).

For example, while the host vehicle is traveling on a highway, when the roll rate of the preceding vehicle rapidly increases, it may be determined that a pothole having a high risk level has been generated, and the pothole avoidance possibility may be calculated as 0.85. In this case, since the pothole avoidance possibility is greater than the reference probability of 0.8, the fourth processing unit 134 may establish a lane line crossing strategy (e.g., execute a full lane change to avoid the hazardous section entirely).

For example, when driving in the city, if the roll rate of the preceding vehicle has increased but it is difficult to change lanes (e.g., due to adjacent traffic or narrow roads), the pothole avoidance possibility may be calculated as 0.5. In this case, since the pothole avoidance possibility is less than the reference probability of 0.8, the fourth processing unit 134 may establish both the lane line crossing strategy and the deflected driving strategy (e.g., providing flexibility to the control module to select based on feasibility in real time).

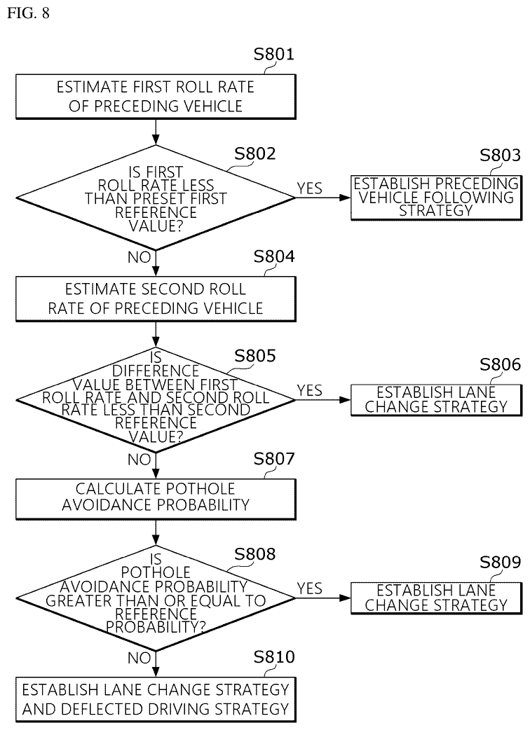

FIG. 8 shows an example of a method of controlling a vehicle. Referring to FIG. 8, the processor determines a first roll rate of a preceding vehicle using a driving image of the preceding vehicle captured by a camera (S801) (e.g., by analyzing bounding box angle variations across consecutive frames).

Next, the processor compares the first roll rate with a preset first reference value (S802) (e.g., to assess whether an abnormal tilt event has occurred due to a road surface anomaly).

If the first roll rate is less than a preset first reference value, the processor establishes a lane change strategy or a lane line crossing strategy (S803) (e.g., preemptively moving to a safer lane in response to mild irregularities or low-confidence cues).

If the first roll rate is greater than or equal to the preset first reference value, the processor determines a yaw rate and a second roll rate of the preceding vehicle using the driving image (S804) (e.g., by applying a vehicle dynamics model or using V2V-sourced motion data).

Next, the processor compares a difference value between the first roll rate and the second roll rate with a second reference value (S805) (e.g., to evaluate the level of agreement or discrepancy between vision-based and model-based roll estimation).

If the difference value between the first roll rate and the second roll rate is less than the preset second reference value, the processor establishes the lane change strategy (S806) (e.g., assuming moderate abnormality consistent across both estimation methods, suggesting a relatively low-risk but actionable pothole).

If the difference value between the first roll rate and the second roll rate is greater than or equal to the preset second reference value, the processor calculates the pothole avoidance possibility using driving information about the preceding vehicle including the first roll rate and the second roll rate and driving information about the host vehicle (S807) (e.g., host vehicle speed, roll rate, steering angle, etc., processed via a rule-based model or neural network).

Next, the processor compares the pothole avoidance possibility with the reference probability (S808) (e.g., a risk threshold such as 0.8 that triggers more conservative or aggressive maneuvering).

If the pothole avoidance possibility is greater than or equal to a preset reference probability, the processor establishes a lane change strategy (S809) (e.g., choosing a full lane change as the safest maneuver in a high-risk scenario).

If the pothole avoidance possibility is less than the preset reference probability, the processor establishes the lane change strategy and a deflected driving strategy based on the pothole avoidance possibility (S810) (e.g., enabling real-time selection of avoidance trajectory based on vehicle dynamics and surrounding traffic feasibility).

The present disclosure is directed to providing a vehicle control device and method capable of responding more effectively to a road defect such as a pothole.

The present disclosure is also directed to providing a vehicle control device and method capable of detecting a pothole generated on a road in real time and calculating a safe driving strategy in real time.

The present disclosure is also directed to providing a vehicle control device and method capable of simultaneously improving the safety and riding comfort of an autonomous vehicle and providing a reliable driving route even in a complex road environment.

According to an example of the present disclosure, there is provided a vehicle control device including one or more processors and a memory configured to store one or more programs executed by the one or more processors, in which the processor is configured to determine a roll rate of a preceding vehicle using a driving image of the preceding vehicle captured by a camera, determine a pothole avoidance possibility using the roll rate, driving information about the preceding vehicle, and driving information about a host vehicle, and calculate a control strategy of the host vehicle based on the pothole avoidance possibility.

The processor may calculate a center line of the preceding vehicle from the driving image and determine a first roll rate using an angle change amount of the center line for each frame.

The processor may determine a second roll rate based on a yaw rate of the preceding vehicle and a speed of the preceding vehicle.

The processor may establish a lane change strategy if the pothole avoidance possibility is greater than or equal to a preset reference probability.

The processor may determine the pothole avoidance possibility using the first roll rate, the second roll rate, a difference value between the first roll rate and the second roll rate, the speed of the preceding vehicle, a speed of the host vehicle, a roll rate of the host vehicle, and a steering angle of the host vehicle.

The processor may include a learning model trained to calculate the pothole avoidance possibility using the first roll rate, the second roll rate, the difference value between the first roll rate and the second roll rate, the speed of the preceding vehicle, the speed of the host vehicle, the roll rate of the host vehicle, and the steering angle of the host vehicle as inputs.

The processor may establish a lane change strategy and a deflected driving strategy based on the pothole avoidance possibility if the pothole avoidance possibility is less than the reference probability.

The processor may establish a preceding vehicle following strategy if the first roll rate is less than a preset first reference value.

The processor may establish a lane change strategy or a lane line crossing strategy if the difference value between the first roll rate and the second roll rate is less than a preset second reference value.

The processor may establish the lane change strategy and a deflected driving strategy based on the pothole avoidance possibility if the difference value between the first roll rate and the second roll rate is greater than or equal to the second reference value.

According to another example of the present disclosure, there is provided a method of controlling a vehicle that is performed by a computing device including one or more processors and a memory configured to store one or more programs executed by the one or more processors, including estimating, by the processor, a roll rate of a preceding vehicle using a driving image of the preceding vehicle captured by a camera, determining, by the processor, a pothole avoidance possibility using the roll rate, driving information about the preceding vehicle, and driving information about a host vehicle, and calculating, by the processor, a control strategy of the host vehicle based on the pothole avoidance possibility.

The estimating of the roll rate may include calculating a center line of the preceding vehicle from the driving image and estimating a first roll rate using an angle change amount of the center line for each frame.

The estimating of the roll rate may include estimating a second roll rate based on a yaw rate of the preceding vehicle and a speed of the preceding vehicle.

The calculating of the control strategy of the host vehicle may include establishing a lane change strategy if the pothole avoidance possibility is greater than or equal to a preset reference probability.

The determining of the pothole avoidance possibility may include determining the pothole avoidance possibility using the first roll rate, the second roll rate, a difference value between the first roll rate and the second roll rate, the speed of the preceding vehicle, a speed of the host vehicle, a roll rate of the host vehicle, and a steering angle of the host vehicle.

The determining of the pothole avoidance possibility may include calculating the pothole avoidance possibility through a learning model trained to calculate the pothole avoidance possibility using the first roll rate, the second roll rate, the difference value between the first roll rate and the second roll rate, the speed of the preceding vehicle, the speed of the host vehicle, the roll rate of the host vehicle, and the steering angle of the host vehicle as inputs.

The calculating of the control strategy of the host vehicle may include establishing a lane change strategy and a deflected driving strategy based on the pothole avoidance possibility if the pothole avoidance possibility is less than the reference probability. The calculating of the control strategy of the host vehicle may include establishing a preceding vehicle following strategy if the first roll rate is less than a preset first reference value.

The calculating of the control strategy of the host vehicle may include establishing a lane change strategy or a lane line crossing strategy if the difference value between the first roll rate and the second roll rate is less than a preset second reference value.

The calculating of the control strategy of the host vehicle may include establishing the lane change strategy and a deflected driving strategy based on the pothole avoidance possibility if the difference value between the first roll rate and the second roll rate is greater than or equal to the second reference value.

The term “˜unit” used in the present example refers to software components or hardware components such as a field-programmable gate array (FPGA) or an application specific integrated circuit (ASIC), and “˜unit” performs certain functions. However, the “˜unit” is not limited to software or hardware. The “˜unit” may be configured to reside in an addressable storage medium, or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

With a vehicle control device and method according to an example, it is possible to detect and avoid a pothole occurring on a road in advance utilizing state information about a preceding vehicle.

In addition, by simultaneously establishing a lane line crossing strategy and a deflected driving strategy, it is possible to flexibly respond to the risk of potholes.

In addition, by reflecting driving information about other vehicles on a driving route, it is possible to respond even in a complex road environment.

In addition, by estimating the presence of a pothole based on a change in the state of a preceding vehicle even if an exact position of the pothole is not identified, it is possible to effectively avoid the pothole.

In this way, the vehicle control device and method can improve the ride comfort, and can be effectively applied to an actual road driving environment.

Although preferred examples of the present disclosure have been described above, it is understood that those skilled in the art can make various changes and modifications to the present disclosure without departing from the spirit and scope of the present disclosure set forth in the claims below.

What is claimed:

1. An apparatus of a vehicle, the apparatus comprising:
one or more processors; and
a memory storing one or more programs that, when executed by the one or more processors communicating with the memory, are configured to cause the apparatus to:
estimate, based on a driving image of a preceding vehicle captured by a camera of the vehicle, a roll rate of the preceding vehicle;
determine a possibility of a pothole avoidance, wherein the possibility is determined based on the roll rate of the preceding vehicle, driving information about the preceding vehicle, and driving information about the vehicle;
output a signal indicating the possibility; and
control, based on the signal and based on an estimated pothole, autonomous driving of the vehicle.

2. The apparatus of claim 1, wherein the one or more programs, when executed by the one or more processors, are configured to cause the apparatus to:
identify, based on the driving image, a center line of the preceding vehicle, and
estimate a first roll rate based on an angle change amount of the center line for each frame associated with the driving image of the preceding vehicle, and
wherein the roll rate of the preceding vehicle comprises the first roll rate.

3. The apparatus of claim 2, wherein the one or more programs, when executed by the one or more processors, are configured to cause the apparatus to estimate a second roll rate based on a yaw rate of the preceding vehicle and a speed of the preceding vehicle, and
wherein the roll rate of the preceding vehicle further comprises the second roll rate.

4. The apparatus of claim 1, wherein the one or more programs, when executed by the one or more processors, are configured to cause the apparatus to determine a lane change strategy based on the possibility being greater than or equal to a preset reference probability value.

5. The apparatus of claim 3, wherein the one or more programs, when executed by the one or more processors, are configured to cause the apparatus to determine the possibility based on:
a difference value between the first roll rate and the second roll rate,
a speed of the vehicle,
the speed of the preceding vehicle,
a roll rate of the vehicle, and
a steering angle of the vehicle.

6. The apparatus of claim 5, wherein the one or more programs, when executed by the one or more processors, are configured to cause the apparatus to determine the possibility by inputting a plurality of input values into a trained learning model, and
wherein the plurality of input values comprises at least two of: the first roll rate, the second roll rate, the difference value between the first roll rate and the second roll rate, the speed of the preceding vehicle, the speed of the vehicle, the roll rate of the vehicle, and the steering angle of the vehicle.

7. The apparatus of claim 1, wherein the one or more programs, when executed by the one or more processors, are configured to cause the apparatus to determine a lane change strategy and a deflected driving strategy based on the possibility being less than a preset reference probability value.

8. The apparatus of claim 3, wherein the one or more programs, when executed by the one or more processors, are configured to cause the apparatus to determine a preceding vehicle following strategy based on the first roll rate being less than a preset first reference value.

9. The apparatus of claim 3, wherein the one or more programs, when executed by the one or more processors, are configured to cause the apparatus to determine a lane change strategy or a lane line crossing strategy based on a difference value between the first roll rate and the second roll rate being less than a preset second reference value.

10. The apparatus of claim 9, wherein the one or more programs, when executed by the one or more processors, are configured to cause the apparatus to determine the lane change strategy and a deflected driving strategy based on the possibility and based on the difference value between the first roll rate and the second roll rate being greater than or equal to the preset second reference value.

11. A method performed by an apparatus of a vehicle, the method comprising:
estimating, based on a driving image of a preceding vehicle captured by a camera of the vehicle, a roll rate of the preceding vehicle;
determining a possibility of a pothole avoidance, wherein the possibility is determined based on the roll rate of the preceding vehicle, driving information about the preceding vehicle, and driving information about the vehicle;
outputting a signal indicating the possibility; and
controlling, based on the signal and based on an estimated pothole, autonomous driving of the vehicle.

12. The method of claim 11, wherein the estimating of the roll rate comprises:
identifying, based on the driving image, a center line of the preceding vehicle; and
estimating a first roll rate based on an angle change amount of the center line for each frame associated with the driving image of the preceding vehicle, and
wherein the roll rate of the preceding vehicle comprises the first roll rate.

13. The method of claim 12, wherein the estimating of the roll rate further comprises estimating a second roll rate based on a yaw rate of the preceding vehicle and a speed of the preceding vehicle, and
wherein the roll rate of the preceding vehicle further comprises the second roll rate.

14. The method of claim 11, wherein the outputting of the signal comprises establishing a lane change strategy based on the possibility being greater than or equal to a preset reference probability value.

15. The method of claim 13, wherein the determining of the possibility comprises determining the possibility based on:
a difference value between the first roll rate and the second roll rate,
a speed of the vehicle,
the speed of the preceding vehicle,
a roll rate of the vehicle, and
a steering angle of the vehicle.

16. The method of claim 15, wherein the determining of the possibility comprises determining the possibility by inputting a plurality of input values into a trained learning model, and
wherein the plurality of input values comprises at least two of: the first roll rate, the second roll rate, the difference value between the first roll rate and the second roll rate, the speed of the preceding vehicle, the speed of the vehicle, the roll rate of the vehicle, and the steering angle of the vehicle.

17. The method of claim 11, wherein the outputting of the signal comprises establishing a lane change strategy and a deflected driving strategy based on the possibility being less than a preset reference probability value.

18. The method of claim 13, wherein the outputting of the signal comprises establishing a preceding vehicle following strategy based on the first roll rate being less than a preset first reference value.

19. An apparatus of a vehicle, the apparatus comprising:
a processor; and
a memory storing at least one instruction that, when executed by the processor communicating with the memory, is configured to cause the apparatus to:
estimate a first roll rate of a preceding vehicle based on image data associated with the preceding vehicle obtained from a camera of the vehicle,
estimate a second roll rate of the preceding vehicle based on motion information associated with the preceding vehicle,
determine, based on the first roll rate and the second roll rate, a likelihood that the preceding vehicle encountered a road surface anomaly,
output a signal indicating the likelihood, and
control, based on the signal, autonomous driving of the vehicle.

20. The apparatus of claim 19, wherein:
the image data indicates a center line inclination of the preceding vehicle in successive image frames;
the motion information comprises at least a yaw rate of the preceding vehicle and a speed of the preceding vehicle; and
the motion information is obtained by vehicle-to-vehicle communication with the preceding vehicle or obtained by a radar of the vehicle.
